(19) United States
(12) Patent Application Publication
(10) Pub. No.: US 2005/0042390 A1
(43) Pub. Date: Feb. 24, 2005

(54) Rotary UV curing method and apparatus

(76) Inventor: Stephen B. Siegel, Chicago, IL (US)

Correspondence Address: Welsh & Katz, Ltd., 22nd Floor, 120 South Riverside Plaza, Chicago, IL, 60606, US

(21) Appl. No.: 10/753,837

(22) Filed: Jan. 7, 2004

Related U.S. Application Data
(63) Continuation-in-part of application No. 10/386,980, filed on Mar. 12, 2003.
(63) Continuation-in-part of application No. 10/339,264, filed on Jan. 9, 2003.

(51) Int. Cl. B05D 3/00; B05C 11/02

(52) U.S. Cl. 427/585; 118/52; 427/553

(57) ABSTRACT

An improved rotary UV curing method and apparatus is provided to more effectively polymerize and cure an UV curable product, article, ink coating or adhesive in or on a disk. Advantageously, the improved rotary UV curing method and apparatus has a special arrangement that provides for rotational movement between an array of UV-LED chips mounted on a panel and a UV curable disk or other UV curable product, article, ink, such as a UV curable coating or adhesive, to better cure the UV photo initiators disk and product. One or more shields can also be provided to protect the UV LED chips from splatter or other objects which could otherwise damage or decrease the light emission, intensity and effectiveness of the UV LED chips.

### CROSS REFERENCE TO RELATED APPLICATIONS

This application is a continuation in part of U.S. application Ser. No. ______ filed Jan. 7, 2004 entitled UV CURING METHOD AND APPARATUS, which is a continuation in part of U.S. application Ser. No. 10/386,690 filed Mar. 12, 2003 and of U.S. application Ser. No. 10/339,264 filed Jan. 9, 2003.

### BACKGROUND OF THE INVENTION

1. Field of the Invention

The present invention relates to a method and apparatus for utilizing ultraviolet (UV) light to cure a disk-shaped product using UV-LED chips mounted in an array and providing for relative movement between the array and the disk-shaped product, thereby to cure a curable ink, coating or adhesive mounted in the disk-shaped product. The inks, coatings and adhesives have UV photo initiators which, when exposed to UV light, convert monomers in the inks, coatings and adhesives to linking polymers to solidify the curable material.

2. Description of the Related Art

Heretofore, UV-LED arrays have been proposed for curing inks, coatings or adhesives.

The prior proposals teach one to stagger rows of UV-LED's in different arrays on a panel positioned closely adjacent a product to be cured, to move the product past the array, to move the array in a generally orbital path to uniformly apply UV light on the product and to inject an inert, heavier than air or lighter than air gas in the area between the panel and the product.

Also it has been learned that different wavelengths of UV light are better suited for different thicknesses of ink, coating or adhesive and/or for different components in the ink coating or adhesive.

For example, thick polymers require longer wavelengths for curing. Surface curing requires shorter wavelengths.

Further, a common use of UV curable adhesives and coatings is in the manufacture of compact disks, CD's.

It is, therefore, desirable to provide an improved UV method and apparatus for applying UV light at one or more wavelengths to a disk-shaped UV curable product to more effectively cure UV inks, coatings and adhesives in or on the product, by causing relative rotation between the UV light and the disk-shaped product.

### BRIEF SUMMARY OF THE INVENTION

According to the present invention, there is provided a method and apparatus for curing an UV curable product, article, ink coating or adhesive in or on a disk including the step of or mechanisms for causing relative rotational movement between an array of UV-LED chips mounted on a panel and a disk containing the UV curable product, article, ink coating or adhesive.

Also, according to the present invention there is provided at least one staggered array of UV LED assemblies on at least one panel with the UV LED assemblies being arranged in rows with each row being staggered from adjacent rows. A mechanism is provided for causing relative rotational movement between the panel and a disk-shaped product.

In one preferred embodiment, the disk-shaped product containing the UV curable product, article or other object to be cured is arranged to rotate. A gas having a molecular weight heavier than air or lighter than air can be injected into the area of rotation of the UV curable product, article or other object having a UV ink, coating, or adhesive thereon as it rotates past a panel of arrays of UV LED assemblies.

In another preferred embodiment, the panel or a + shaped (cross-shaped) structure comprising four panels is caused to rotate relative to the disk-shaped product.

Advantageously, the method and apparatus of the present invention provide better uniformity of light application from a flat panel having an array of UV-LED's. This result can be obtained when the product and/or the light fixture is rotated relative to and across the UV light beams from the UV-LED assemblies. The rotational movement has the ability to provide enhanced uniformity. Desirably, the rotation of the UV curable product or the rotation of the light array provides outstanding uniformity of UV light and UV curing of the product.

A more detailed explanation of the invention is provided in the following detailed description and claims taken in conjunction with the accompanying drawings.

### BRIEF DESCRIPTION OF THE DRAWINGS

FIG. 1 is a top plan view of a panel or substrate mounting an array of UV-LED chips positioned above a disk-shaped product, which is caused to rotate underneath the array;

FIG. 2 is a vertical sectional view through the disk and panel or substrate shown in FIG. 1 and also shows a dispensing apparatus for dispensing liquid having a UV photo initiator therein onto the disk-shaped product as it rotates under the dispensing apparatus;

FIG. 3 is a top plan view of a + shaped (cross-shaped) arrangement of four panels each having an array of UV-LED chips mounted thereon for rotation above a disk; and

FIG. 4 is a vertical, partially sectional view of the cross-shaped panel assembly shown in FIG. 3 and shows a glass or plastic shield between the UV-LED chips in the four arrays and the disk therebeneath and also shows an auxiliary array of UV-LED chips on the side of the disk and a glass or plastic protecting shield between the auxiliary array and the side of the disk.

### DETAILED DESCRIPTION OF THE INVENTION

A detailed description of the preferred embodiments and best modes for practicing the invention are described herein.

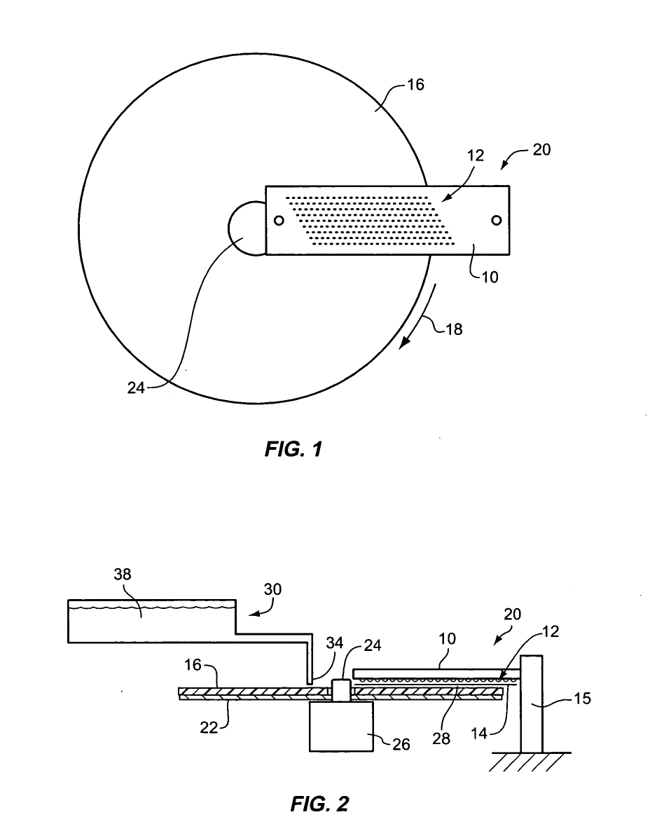

Referring now to FIG. 1, there is illustrated therein a generally rectangular-shaped, horizontal, substantially planar or flat, fixed panel 10 mounting an array 12 of staggered, offset UV-LED chips 14. It will be understood that the array 12 shown on the upper side of the panel 10 is for the convenience of showing the array 12 and that actually, the array 12 of UV-LED chips 14 are mounted on the underside of the panel 10. The array 12 of UV-LED chips 14 is better shown in FIG. 2. The panel 10 can be supported by an upright vertically disposed support structure in the form of a cantilevered base 15 (FIG. 2), so that the panel 10 can be positioned over a generally disk-shaped product 16, or, simply a disk 16. The arrow 18 in FIG. 1 indicates the direction of rotation of the disk 16 in a UV-LED chip apparatus 20 including the panel 10 for curing UV photo initiators on or in the disk 16.

As shown in FIG. 2, the apparatus 20 can include a support pad 22 for supporting the disk 16. The support pad 22 can be fixed to an output shaft 24 at one end of a motor 26. The motor 26 can be energized periodically to rotate a disk 16 placed on the support pad 22 to enable UV light from the UV-LED chip array 12 to cure an UV curable product, article, ink coating or adhesive in or on the disk 16. Between the array 12 of UV-LED chips 14 and the disk 16 there can be positioned a glass or plastic sheet or plate 28 for protecting the UV-LED chips in the array 12 from splatter.

The UV-LED chips 14 are preferably arranged in an offset staggered array 12 on at least one panel 10. If desired, at least one row of UV LED chips 14 can emit light in the visible light spectrum whereby a user can visually determine that power is being supplied to the array 12 of UV LED chips 14.

Further, a heavier than air or lighter than air, non-oxygen, non-combustion-supporting gas can be provided in the area between the panel and the product to enhance UV curing. Also, the gas can be circulated by a fan to enhance cooling of the UV-LED chips 14 and heat dissipating fins can be mounted on the top side of panel 10 to further enhance cooling of the UV-LED chips 14.

Also shown in FIG. 2, is a dispenser 30 for dispensing a liquid 32 having one or more UV photo initiators therein onto the upper surface of the rotating disk 16. The dispenser 30 is preferably positioned above the disk 16 and can have a dispensing point 34 near the center of the disk 16 so that that liquid 32 dispensed can flow by centrifugal force radially outwardly to a periphery of the disk 16 as the disk 16 rotates. At the same time, the UV curable liquid coated portion of the disk 16 passing beneath the array 12 of UV-LED chips can be cured, polymerized and solidified, by the UV light emitted from the UV-LED chips 14.

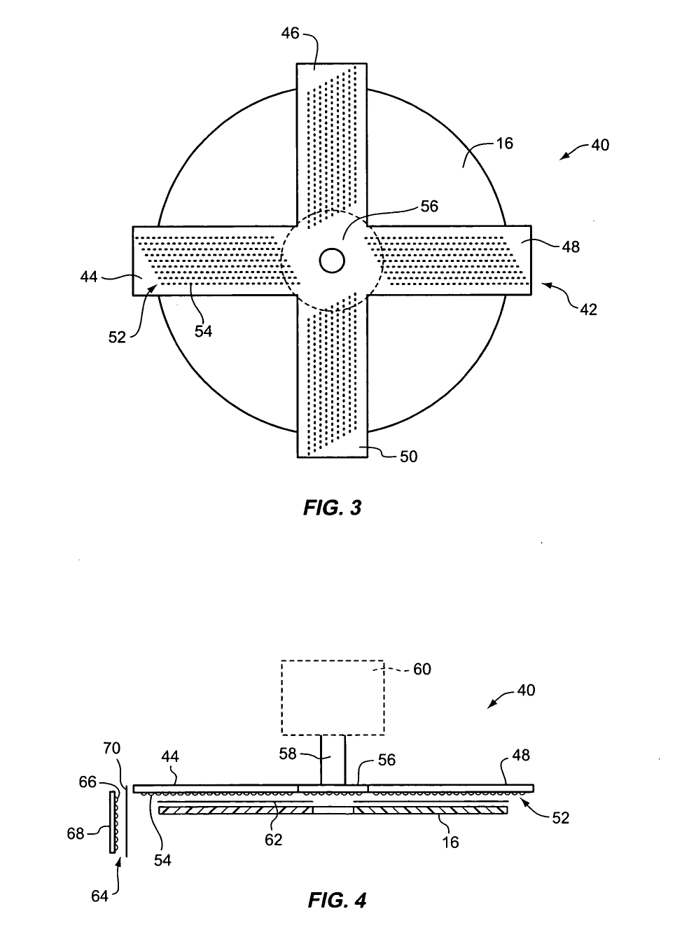

In FIG. 3, there is illustrated another UV-LED chip apparatus 40 for curing UV photo initiators in or on a stationary or fixed disk 16. As shown, the apparatus 40 includes a cross-shaped or + shaped structure 42 including four rotatable, generally horizontal, substantially flat or planar portions or panels 44, 46, 48 and 50, each mounting an array 52 of UV-LED chips 54. In it's simplest form, the structure 40 can include at least one elongated panel 44, 46, 48 or 50. The UV LED chips 54 are preferably arranged in an offset staggered array on at least one panel 44, 46, 48 or 50. Also, while the arrays 52 are shown in FIG. 3 on the upper side of each panel portion 44-50, it will be understood that this is only for the convenience of showing the arrays 52 and that actually, the arrays 52 are mounted on the underside of each panel portion 44-50, as better shown in FIG. 4.

In the apparatus 40 of FIG. 4, a center panel portion 56 that is integral or connected to the panel portions 44-50 having the four arrays 52 of UV-LED chips, is mounted to a shaft 58 at one end of a motor 60, so that the panel portions 44-50 and the arrays 52 can be rotated relative to the disk 16. It will be understood that a suitable support can be provided for the disk 16, such as a pedestal (not shown).

If desired at least one row of UV LED chips 54 can emit light in the visible light spectrum whereby a user can visually determine that power is being supplied to the array (s) 52 of UV LED chips 54.

Further, a heavier than air or lighter than air, non-oxygen, non-combustion-supporting gas can be provided in the area between the panel portions 44, 46, 48 and 50 and the product to enhance curing. Also, the gas can be circulated by a fan to enhance cooling of the UV-LED chips 54 and heat dissipating fins can be mounted on the top side of the panels 44-50 to further enhance cooling of the UV-LED chips 54.

Advantageously, in the apparatus 40 of FIG. 4, a glass or plastic plate 62 is positioned between the UV-LED arrays 52 mounted on the undersides of the four panel portions 44-50 and the top of the disk 16. The disk 16 can have one or more UV curable photo initiators in or on the upper surface of the disk 16.

In the apparatus 40 of FIG. 4, there is provided at least one, generally vertically arranged, auxiliary array 64 of UV-LED chips 66 that can be mounted on a generally upright vertical panel 68 positioned adjacent the periphery of the disk 16 to provide curing light at the side or periphery of the disk 16. Also, a plastic or glass sheet or plate 70 can be positioned between the auxiliary array 64 and the disk 16 to shield the UV-LED chips 66 from splatter.

If desired, the upright panel 68 (FIG. 4) can be attached to and/or depend from one of the horizontal panel portions 44-50. Alternatively, each of the horizontal panel portions 44-50 can have an upright panel 68 attached thereto and/or depending therefrom, with the shielding sheet or plate 70 attached to the upright panel(s) 68 in front of the array 64.

The glass or plastic sheets described above for the apparatus of FIGS. 2 and 4 are preferably transparent or translucent, as well as rigid or semi-rigid, to provide impact-resistant light transmissive barriers to protect and shield the UV LED chips from splatter, dust, particularly, liquid containing UV photo initiators and other liquids.

The disk-shaped product or the at least one elongate panel can be rotated a predetermined number of times between two and twenty (20) to enhance polymerization and curing of the UV curable photo-initiators. Insertion and ejection mechanisms can be provided for sequentially moving a disk-shaped product onto and off of the stationary or rotatable support pad or pedestal in a mass production operation of the apparatus of the present invention.

Among the many advantages of the rotary UV curing method and apparatus of the invention are:
1. The disk-shaped product or at least one panel having an array of offset staggered UV-LED chips thereon can be rotated.
2. A transparent or translucent glass or plastic shield can be provided for maintaining the UV-LED chips free from debris.
3. A non-oxygen gas can be provided for enhancing curing and can be circulated to enhance cooling of the UV-LED chips.
4. Outstanding curing.
5. Excellent results.
6. Greater product output.
7. Super quality.
8. Fewer defective products.
9. User friendly.
10. Economical.
11. Efficient.
12. Effective.

From the foregoing description, it will be apparent that the method and apparatus of the present invention have a number of advantages, some of which have been described above and others of which are inherent in the invention and examples.

Although embodiments of the invention have been shown and described, it will be understood that various modifications and substitutions, as well as rearrangements of components, parts, equipment, apparatus, process (method) steps, and uses thereof, can be made by those skilled in the art without departing from the teachings of the invention. Accordingly, the scope of the invention is only to be limited as necessitated by the accompanying claims.

1. A method for curing an UV curable product, article, ink coating or adhesive in or on a disk including the step of: causing relative rotational movement between an array of UV-LED chips mounted on a panel and a disk containing the UV curable product, article, ink coating or adhesive.

2. The method of claim 1, wherein the disk is rotated relative to a substantially fixed panel mounting an array of UV-LED chips.

3. The method of claim 1, wherein a panel mounting the array of UV-LED chips is rotated relative to the disk having the UV curable product, article, ink coating or adhesive therein or thereon.

4. The method of claim 1 including the step of arranging the UV-LED chips in an offset staggered array on at least one panel.

5. The method of claim 1 including the step of positioning a glass or plastic sheet or plate between the array of UV-LED chips and the disk to help protect the UV-LED chips from splatter of liquid containing UV photo initiators.

6. The method of claim 1 including the step of arranging an auxiliary array of UV-LED chips at the periphery of the disk for emitting UV light at the disk form a side of the disk.

7. The method of claim 6 including the step of arranging a glass or plastic sheet or plate between the array of UV-LED chips and the disk to help protect the UV-LED chips from splatter of liquid containing UV photo initiators.

8. An apparatus for applying UV light to UV photo initiators in an UV curable product, article, ink coating or adhesive in or on a disk-shaped product comprising:
at least one elongated panel mounting an array of UV-LED chips; and
a motor operatively associated with said panel for causing relative rotation between said panel and the disk-shaped product to be cured.

9. The apparatus of claim 8, comprising four elongated panels each containing an array of UV-LED chips, and said panels being arranged in a generally + pattern relative to the disk-shaped product to be cured.

10. The apparatus of claim 8, comprising a generally cylindrical pad for supporting the disk-shaped product, and said cylindrical pad being operatively connected to and rotated by said motor.

11. The apparatus of claim 10, wherein UV-LED chips are arranged in an offset staggered array on at least one panel.

12. The apparatus of claim 10, including a liquid dispensing device for dispensing a liquid having a photo initiator therein onto the surface of a rotating disk-shaped product at a point near the center of the disk so that centrifugal force causes the liquid to move radially, outwardly from the point of dispensing to an outer periphery of the disk-shaped product.

13. The apparatus of claim 10, wherein a glass or plastic sheet or plate is positioned between the array of UV-LED chips and the disk-shaped product to help protect the UV-LED chips from splatter of liquid containing UV photo initiators.

14. The apparatus of claim 8, comprising at least one generally horizontal panel positioned adjacent the disk-shaped, said horizontal panel being operatively connected to and rotated by said motor.

15. The apparatus of claim 14, wherein UV-LED chips are arranged in an offset staggered array on at least one panel.

16. The apparatus of claim 14, comprising four substantially horizontal panels containing an array of UV-LED chips, said horizontal panel being arranged in a generally cross-shaped pattern relative to the disk-shaped product to be cured.

17. The apparatus of claim 14, wherein a shield selected from the group consisting of a glass sheet, plastic sheet, and plate, is positioned between the array of UV-LED chips and the disk-shaped product to help protect the UV-LED chips from splatter of liquid containing UV photo initiators.

18. The apparatus of claim 14, wherein said motor comprises a shaft operatively connected to at least one panel containing the array of UV-LED chips adjacent a disk-shaped product.

19. The apparatus of claim 8, including an auxiliary array of UV-LED chips arranged at the periphery of the disk-shaped product for emitting UV light at the disk-shaped product from a side of the disk-shaped product.

20. The apparatus of claim 19, including a shield selected from the group consisting of a glass sheet, plastic sheet, and plate, positioned between the auxiliary array of UV-LED chips and the disk-shaped product to help protect the UV-LED chips from splatter of liquid containing UV photo initiators.
